(19) United States
(12) Patent Application Publication
(10) Pub. No.: US 2006/0202559 A1
(43) Pub. Date: Sep. 14, 2006

(54) Power unit

(75) Inventors: Shoji Hashimoto, Wako-shi (JP); Motohiro Shimizu, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/367,278

(22) Filed: Mar. 6, 2006

(30) Foreign Application Priority Data
Mar. 8, 2005 (JP) 2005-064426

(51) Int. Cl. H02J 9/00

(52) U.S. Cl. 307/64

(57) ABSTRACT

A system interconnection control section 7 interconnects and parallels off an output from a generator 1 with a system 9, and supplies an output from the generator 1 to a load 10. A selection switch 24 that selects operation modes of the generator 1 is provided. The operation modes are an interconnected operation mode to shut down operation of the generator 1 and an isolated operation mode to operate the generator 1 after disconnecting the output from the generator 1 from the system, when a power of the system 9 has been stopped. During a power failure, the selection switch 24 is switched to select a start and a shutdown of an isolated operation.

### BACKGROUND OF THE INVENTION

1. Field of the Invention

The present invention relates to a power unit such as a small-sized cogeneration unit, and particularly, to a power unit that is capable of an isolated or independent operation when a commercial power system with which a power output from the power unit has been interconnected was cut off.

2. Description of the Related Art

In recent years, the need to protect the global environment has been trumpeted, and a cogeneration unit being a private power generating installation that generates power and supplies hot water using an engine such as a gas engine using town gas or the like as fuel as a power source has been drawing great attention. With this type of cogeneration unit, since it is often the case that a heat energy generated as a result of power generation cannot be consumed simultaneously with electric power, from the standpoint of thoroughly using this heat energy, a heat demand-priority unit that prevents the calorific value being generated beyond consumption has been proposed. For example, according to a cogeneration unit described in Japanese Published Unexamined Patent Application No. 2000-87801, a power output from the cogeneration unit is interconnected with a commercial power system in advance, and the cogeneration unit receives a power supply from the commercial power system when there is no heat load while it is operated only when there is a heat load, whereby operating efficiency is improved.

Patent Document: Japanese Published Unexamined Patent Application No. 2000-87801

As the conventional cogeneration unit described in the foregoing patent document, a small-sized household type has been used in recent years. This household cogeneration unit is generally constructed, for convenience of a system interconnection, so that operation is shut down in a case of a system power failure so that it is not solely operated, that is, so as not to allow an isolated operation. However, this causes an inconvenience such that the cogeneration unit being a power generating installation specially owned cannot be used in such an emergency as a power failure.

### SUMMARY OF THE INVENTION

It is an object of the present invention to provide a power unit such as a cogeneration unit that is capable of an isolated operation by automatically paralleling off an interconnection with an electric power system in an emergency such as a power failure.

The present invention is characterized by setting an interconnected operation mode that can automatically shut down operation of the power unit during a power failure of the electric power system and an isolated operation mode that can parallel off an interconnection with the system to allow an isolated operation of the power unit and including a mode selection switch that can selectively switch these operation modes.

Moreover, the present invention is also characterized in that the power unit forms a cogeneration unit along with an exhaust heat recovery section that recovers exhaust heat generated as a result of power generation.

According to the invention having the above-described characteristics, the power unit can be operated in a mode selected according to an operation of the mode selection switch during a power failure. For example, when a household is gone out with the interconnected operation mode has selected, operation of the power unit is automatically shut down when a power failure occurs while the household is gone out. On the other hand, the household has selected the isolated operation mode while they are at home, an emergency power supply can be secured by an isolated operation during a power failure. Accordingly, it is possible to flexibly correspond to an electric power usage pattern, such that there is no inconvenience in most situations even if the power unit shuts down during a power failure while the household is not stayed and the household often wishes to immediately relay and operate in-use electric appliances by an emergency power supply during a power failure while at home, by operating the mode selection switch.

Even in the isolated operation during a power failure, when electric power supply becomes no longer necessary, it is possible to shut down operation of the power unit by a simple operation to select the interconnected operation mode with the mode selection switch. In contrast to this, when an electric power demand arises when operation of the power unit has been shut down during a power failure, it is possible to start operation of the power unit by selecting the isolated operation mode with the mode selection switch.

When the power unit is a constituent part of a cogeneration unit, by manually switching the mode selection switch according to not only whether there is an electric power demand but also whether there is a heat demand, it is possible to flexibly make the cogeneration unit available or unavailable regardless of being in a power failure.

As such, it is unnecessary to provide a forced shutdown switch and the like to forcedly shut down an isolated operation during the isolated operation or a forced start-up switch and the like to forcedly start up a generator during a shutdown owing to a power failure separately from the switch that can select the operation modes.

### BRIEF DESCRIPTION OF THE DRAWINGS

FIG. 1 is an enlarged view of an operation panel provided on a cogeneration unit according to an embodiment of the present invention;

FIG. 2 is block diagram showing a configuration of a cogeneration unit according to an embodiment of the present invention;

FIG. 3 is a one-line wiring diagram of an electrical output producing section of a cogeneration unit according to an embodiment of the present invention;

FIG. 4 is a timing chart showing operations of a cogeneration unit according to an embodiment of the present invention;

FIG. 5 is an external perspective view of a cogeneration unit according to an embodiment of the present invention;

FIG. 6 is a timing chart showing operations in an isolated operation mode; and

FIG. 7 is a timing chart showing operations in an interconnected operation mode.

### DETAILED DESCRIPTION OF THE PREFERRED EMBODIMENTS

Hereinafter, an embodiment of the present invention will be described in detail with reference to the drawings. FIG. 2 is a block diagram showing a configuration of a cogeneration unit, being an example of the power unit, provided by interconnecting an engine generator with a commercial power system. In FIG. 2, a generator 1 is a 3-phase multipolar magnet-type engine driven generator where a rotor is driven by an engine E and generates an alternating-current power according to the number of engine revolutions. The generator 1 also serves as an electric motor that can also operate as an electric starter motor for the engine E. The engine E is, for example, a gas engine using town gas as a fuel and is provided with an electronic governor that controls to converge the number of revolutions to a target number of revolutions.

A rectifier circuit 2 has a bridge-connected rectifying device (unillustrated) and full-wave rectifies an output from the generator 1. Switching elements (unillustrated) such as FETs have been connected in parallel to the rectifying device. These switching elements are controlled, when the engine E is started, so as to drive the generator 1 as an engine starter motor. By turning on and off the switching elements of the rectifier circuit 2, a direct-current voltage applied via a bidirectional DC-DC converter 4 from a battery 5 can be converted to a 3-phase AC voltage and applied to the generator 1. That is, the rectifier circuit 2 has a function as a driving inverter of the engine starter motor.

An inverse transformation section 3 has a DC regulator (switching converter) 3-1 and an inverter 3-2 and outputs an output from the rectifier circuit 2 after converting the same to an alternating-current power of a predetermined frequency. This switching converter 3-1 functions so that an output fluctuation in the generator 1 or battery 5 does not effect an input voltage into the inverter 3-2. The inverter 3-2 has a function to convert an output alternating current from the generator 1 to an alternating current of the same quality (with respect to voltage, frequency, noise, and the like) as that of a system 9 and to interconnect the same in synchronization with the phase of the system 9, that is, a system interconnection control section. An example of a device having the system interconnection function has been disclosed in Japanese Published Examined Patent Application No. H04-10302.

An output from the inverter 3-2 is interconnected with the commercial power system 9 via a switching device (ATS) 7 and a switchboard 8 and is also connected to an electric load 10. The ATS 7 is switched over depending on whether to interconnect an output from the generator 1 with the system 9 or parallel off the generator 1 from the system for an isolated operation (in an isolated operation mode). A concrete example of switching in interconnection and in an isolated operation mode will be described later in terms of FIG. 1 and the like.

The battery 5 is an external direct-current power supply that supplies an auxiliary power for a direct-current power supply based on a power of the generator 1 according to necessity. As a means for raising voltage of the battery 5 and supplying the same to the inverse transformation section 3, the bidirectional DC-DC converter 4 is connected to the output side of the rectifier circuit 2, that is, the input side of the inverse transformation section 3. The bidirectional DC-DC converter 4 has a function to charge the battery 5 with an output from the rectifier circuit 2 when the generator output is sufficient and the residual quantity of the battery 5 is small. In the following, the battery 5-side of the bidirectional DC-DC converter 4 is sometimes referred to as a primary side, and the rectifier circuit 2-side, as a secondary side. The battery 5 is, for example, a 12V battery generally used as a power supply of the engine starter motor.

For the engine E, a water cooler 11 served as an exhaust heat recovery section to recover exhaust heat from the engine E is provided, and a duct line 12 of a cooling water that circulates in the water cooler 11 is laid so as to pass through the inside of a hot-water tank 13. Heat generated as a result of an operation of the engine E is recovered by a heat exchange in the water cooler 11 and is supplied to the hot-water tank 13 via the heat transfer medium (cooling water) in the duct line. It is preferable that a heat recovery from the engine E covers all high-temperature parts including a muffler and the like of the engine E.

Now, operations of the above-described cogeneration unit will be described. The bidirectional DC-DC converter 4 is driven by an identical driving signal so that the primary side and the secondary side are completely synchronized. This driving form allows the bidirectional DC-DC converter 4 to bidirectionally carry out a power conversion.

During start-up of the engine, DC voltage of the battery 5 is raised by the bidirectional DC-DC converter 4 based on a relative voltage difference between the primary side and secondary side owing to a transformer winding ratio of the bidirectional DC-DC converter 4, and the raised DC voltage is applied to the driving inverter (rectifier circuit) 2. The driving inverter 2 is driven by switching upon a start command from an unillustrated control section. When a voltage converted to a 3-phase alternating current as a result of the switching is applied to a stator coil of the generator 1, the rotor of the generator 1 is rotated to start the engine E coupled with this rotor. That is, the generator 1 functions as an engine starter motor.

After the engine E is started up, the generator 1 is driven by the engine E, and the switching operation of the driving inverter 2 is stopped. Output from the generator 1 is rectified by the rectifier circuit (driving inverter) 2, regulated in voltage by the switching converter 3-1 of the inverse transformation section 3, and is further converted to an alternating current power of a predetermined frequency by the inverter 3-2 so as to be outputted.

If the residual quantity of the battery 5 is small, the battery 5 is charged with an output from the rectifier circuit 2 through the bidirectional DC-DC converter 4. Namely, if a converting output from the battery 5 is lower than an output voltage from the rectifier circuit 2, based on a relative voltage difference between the primary side and secondary side owing to a transformer winding ratio of the bidirectional DC-DC converter 4, a power conversion is carried out so that the battery 5 is charged with an output from the rectifying circuit 2.

This cogeneration unit is capable of an isolated operation as an emergency power supply in, for example, a case of a power failure of the system 9. A switching example of the ATS 7 in system interconnection and in an isolated operation will now be described.

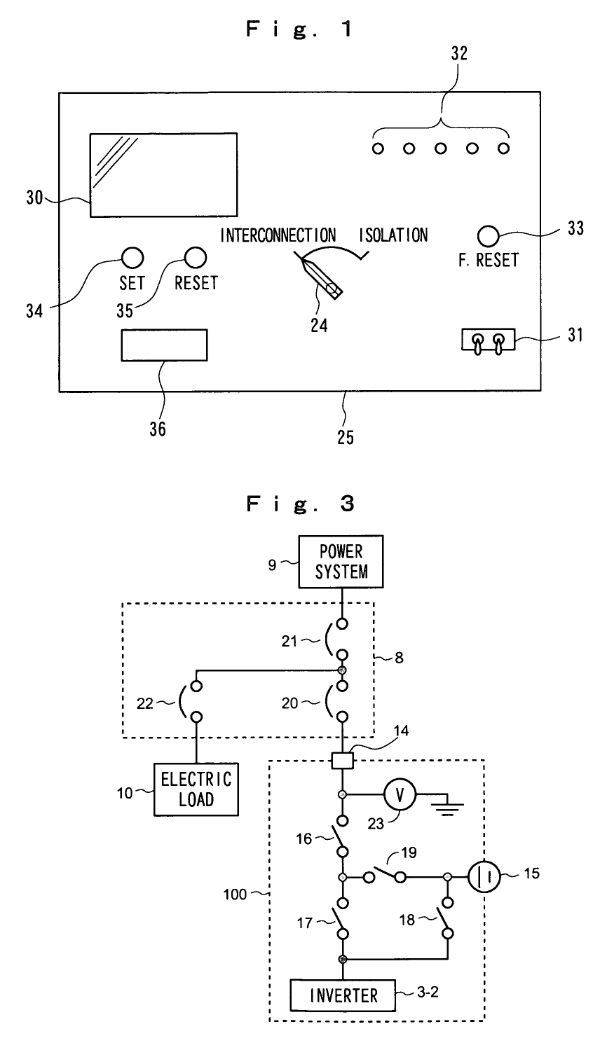

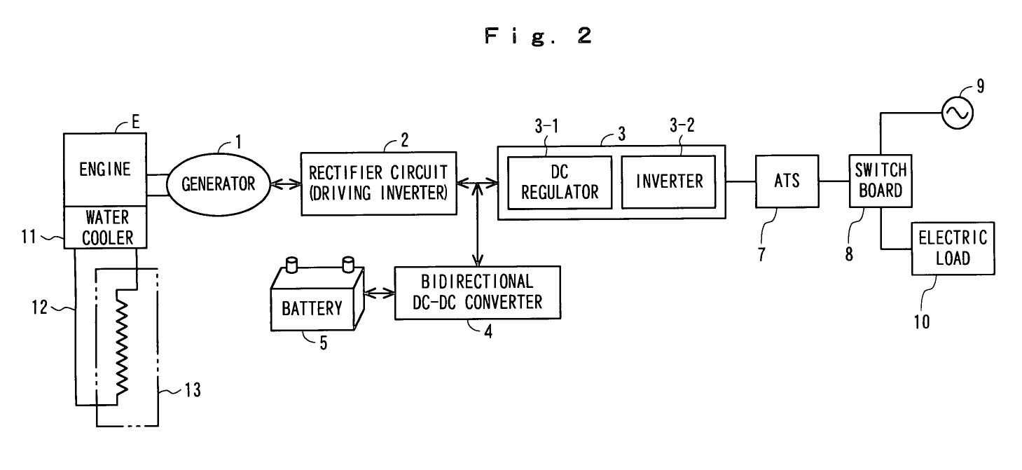

FIG. 3 is a single-line wiring diagram showing a wiring example among a cogeneration unit, a system, and an electric load. In FIG. 3, the cogeneration unit 100 includes an interconnection output terminal 14 as a first output terminal and an isolation output terminal 15 as a second output terminal. The isolation output terminal 15 can be an outlet provided on a frame of the cogeneration unit 100. The interconnection output terminal 14 is connected to the inverter 3-2 via an isolation interlock switch 16 composed of an electromagnetic contact and an interconnection switch 17 connected to this switch 16 in series. The isolated output terminal 15 is connected to the inverter 3-2 via an isolation switch 18 composed of an electromagnetic contact. Furthermore, on a line that connects a point between the isolation interlock switch 16 and interconnection switch 17 and a point between the isolation terminal 15 and isolation switch 18, an output selector switch 19 is provided as a third switch.

The interconnection output terminal 14 is connected to the system 9 via a breaker 20 for the exclusive use of the cogeneration unit 100 and a main breaker 21. In addition, a sub-breaker 22 is provided in parallel with the breaker 20. The electric load 10 is connected to the interconnection output terminal 14 via the sub-breaker 22 and breaker 20 for the exclusive use of the cogeneration unit 100 and is also connected to the system 9 via the sub-breaker 22 and main breaker 21. The breaker 20, main breaker 21, and sub-breaker 22 are included in the switch board 8. A voltage detector 23 for measuring potential in the interconnection output terminal 14 is provided.

By the above-described construction, a generated electric power from the generator 1 is interconnected with the system 9 via the interconnection output terminal 14 and supplied to the electric load 10 and can also be externally drawn out of the isolation output terminal 15 via the isolation switch 18. Moreover, to the isolation output terminal 15, a power can be drawn out of the system 9 via the output selector switch 19 and isolation interlock switch 16 as well as the breaker 20 and main breaker 21.

During system interconnection, the isolation interlock switch 16, interconnection switch 17, and output selector switch 19 are switched on, and the isolation switch 18 is switched off. Accordingly, in system interconnection, the inverter 3-2 is connected to the electric load 10 via the interconnection switch 17, the isolation interlock switch 16 and the breakers 20 and sub-breaker 22 in the switch board 8, which makes it possible to supply an output from the generator 1 to the electric load 10. Furthermore, since the inverter 3-2 is connected to the isolation output terminal 15 via the interconnection switch 17 and output selector switch 19, it also becomes possible to supply an output from the generator 1 to an unillustrated electric load connected to the isolation output terminal 15.

And also, the system 9 is connected to the electric load 10 via the main breaker 21 and sub-breaker 22 and is also connected to the isolation output terminal 15 via the main breaker 21 and breaker 20 as well as the isolation interlock switch 16 and output selector switch 19. Accordingly, it becomes possible to supply a power from the system 9 to the electric load 10 and unillustrated another electric load connected to the isolation output terminal 15.

When a power failure of the system 9 has been detected, the output selector switch 19 and interconnection switch 17 are switched off, and the isolation switch 18 is switched on. Accordingly, when a power failure of the system 9 has been detected, it becomes possible to produce only an output by the generator 1 from the isolation output terminal 15 via the isolation switch 18. As such, during a power failure, a power output from the generator 1 can be utilized by using the electric load 10 reconnected to the isolation output terminal 15 or by connecting an electric load different from the electric load 10 to the isolation output terminal 15.

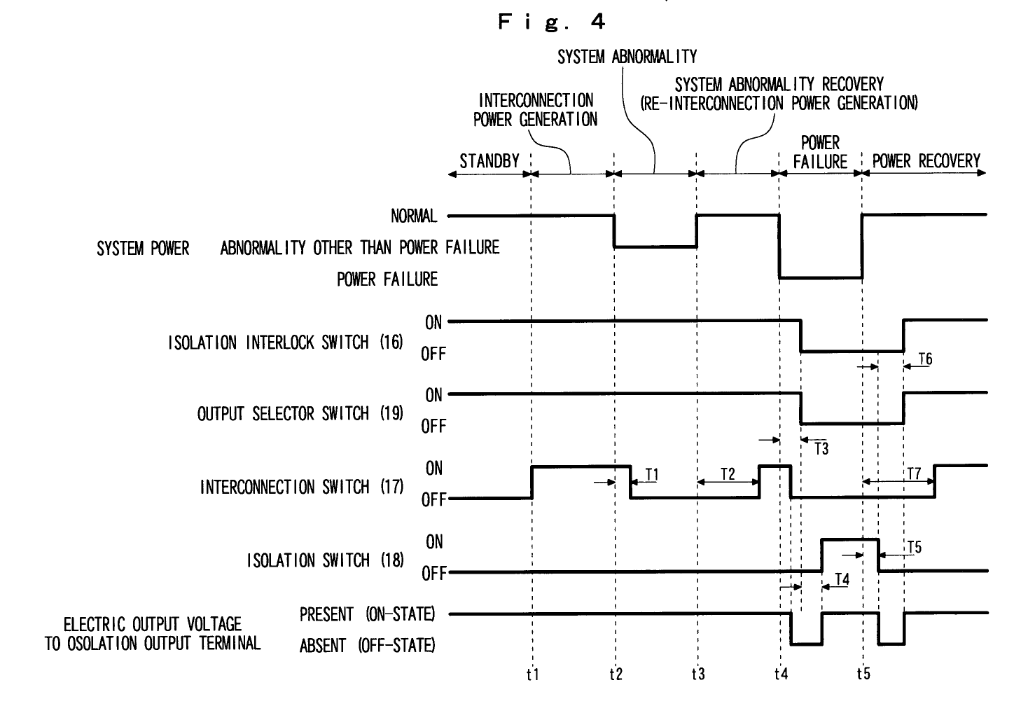

Next, with reference to a timing chart of FIG. 4, description will be given of operation timing of the switches 16 to 19 when the system 9 is abnormal during a power failure. First, when the system 9 is normal and the generator 1 is in standby, the isolation interlock switch 16 and output selector switch 19 are on, and the interconnection switch 17 and isolation switch 18 are off. Then, the interconnection switch 17 is turned on at a time (timing t1) where the generator 1 is operated to attain a system interconnection.

At a timing t2 where an abnormality, such as an occurrence of a voltage fluctuation more than a predetermined value, other than a power failure has occurred, in order to release the system interconnection, the interconnection switch 17 is turned off after a predetermined time T1 from the timing t2. Since this case is not a power failure, power is supplied to the electric load 10 from the system 9. In addition, since the isolation interlock switch 16 is maintained at ON as it is, it is possible to supply power to the unillustrated electric load connected to the isolation output terminal 15 via the isolation interlock switch 16 and output selector switch 19.

When the system 9 has returned to normal at a timing t3, the interconnection switch 17 is turned on after an elapse of a predetermined time T2 therefrom, and the generator 1 is again interconnected with the system 9 via the interconnection output terminal 14 to make it possible to supply power to the electric load 10.

Operations during a power failure will now be described. When a power failure of the system 9 has occurred at a timing t4, the interconnection switch 17 is first turned off. Since the isolation switch 18 has been switched off in an interconnected operation, by switching off this interconnection switch 17, the line between the inverter 3-2 and interconnection output terminal 14 is first interrupted when a power failure of the system 9 has been detected. That is, no output voltage from the generator 1 is produced at the interconnection output terminal 14. The power failure of the system 9 is carried out based on abnormality detection by phase jumping or frequency monitoring by using a widely known method.

When a power failure has continued until an elapse of a predetermined time T3, that is, if it has been confirmed that this case is not an instantaneous power failure based on that a system voltage indicates a zero voltage (0V) at the voltage detector 23, the isolation interlock switch 16 and output selector switch 19 are turned off. After a delay for a time T4 from turning off the isolation interlock switch 16 and output selector switch 19, the isolation switch 18 is turned on. By switching on the isolation switch 18 with the time delay, it becomes possible to prevent an output voltage from the generator 1 from being produced at the interconnection output terminal 14 via the isolation switch 18, output selector switch 19, and isolation interlock switch 16 from the inverter 3-2.

When the system 9 has recovered from the power failure at a timing t5, that is, when a predetermined system voltage has been detected by the voltage detector 23, the isolation switch 18 is turned off after the system voltage has been maintained the predetermined system voltage for a time T5.

If the isolation switch 18 has been turned off, the isolation interlock switch 16 and output selector switch 19 are turned on after an elapse of a time T6. This completes a preparation to restore a connection with the system 9.

After a completion of the preparation to restore a connection with the system 9, the interconnection switch 17 is switched on. By switching on the interconnection switch 17, an output from the generator 1 is interconnected with the system. In such a manner, the generator 1 is interconnected after a power supply from the system 9 has been enabled. A time T7 is a time where a re-interconnection has been stopped after a power recovery. By prioritizing a power supply from the system 9, it becomes possible to prevent the generator 1 from entirely bearing the electric load 10 and the load connected to the isolation output terminal 15.

Although the output voltage to the isolation output terminal 15 cannot maintain a predetermined voltage for a time until the isolation switch 18 is turned on when a power failure has occurred and for a time until the isolation interlock switch 16 and output selector switch 19 are turned on after the isolation switch 18 has been turned off when the power has recovered, for 100 to 300 milliseconds, this does not adversely effect most of the loads since it is an instantaneous interruption.

According to the above-described embodiment, in the system capable of a system interconnection, a power output from the generator 1 can be produced from the isolation output terminal 19 by switching of the switches in the cogeneration unit. Accordingly, it is easy to utilize the cogeneration unit for an emergency power supply as it is during a power failure or the like.

Although the operations in the foregoing are operations corresponding to a power failure and a power recovery when the cogeneration unit is being operated in system interconnection, the operations are the same when the cogeneration unit is disconnected from the system 9 in advance and is operated in an isolated operation mode.

When the isolated operation mode has been selected, similar to the case of a power failure during an interconnected operation, first, the interconnection switch 17 is switched off and the output selector switch 19 is switched off. Then, after it has been detected that there is no voltage being applied between the system 9 and inverter 3-2, the isolation switch 18 is switched on. The inverter 3-2 and the isolation output terminal 15 are connected by switching on the isolation switch 18, which makes it possible to supply power not from the system 9 but solely from the generator 1.

In addition, when the unit has been switched from the isolation operation mode to an interconnected operation mode, similar to the recovery from a power failure, first, the isolation switch 18 is switched off, and then the interconnection switch 17 and output selector switch 19 are switched on. Thereby, the output side of the inverter 3-2 is connected to both the interconnection output terminal 14 and isolation output terminal 15, and an output from the generator 1 is interconnected with the system 9.

Operation of the isolation interlock switch 16, interconnection switch 17, isolation switch 18, and output selector switch 19 are carried out by controlling current supply for coils to drive these respective switches. Then, the coils can be controlled by use of a microcomputer corresponding to a mode instruction by a selection switch (described later) or to a power failure or a power recovery based on a voltage detected by the voltage detector 23.

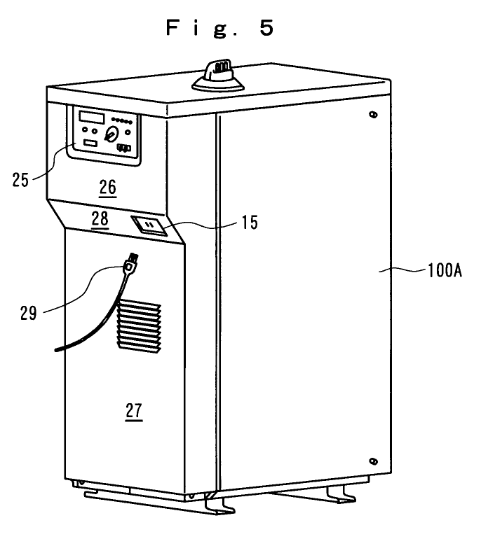

FIG. 5 is an external perspective view of a cogeneration unit. In FIG. 5, a casing 100A of the cogeneration unit 100 is substantially a rectangular parallelepiped, which internally houses the body of the cogeneration unit 100 excluding, out of the components described in FIG. 2, the switchboard 8, a wiring from the ATS 7 to the switchboard 8, that is, from the interconnection output terminal 14 to the switchboard 8, a wiring from the switchboard 8 to the electric load 10, and the like. In a front upper portion of the casing 100A, an operation panel 25 is provided. A front lower portion of the casing 100A has a face 27 retracted in the back relative to a face 26 in the upper portion, and there is a slope 28 between the face 26 and face 27. And, on this slope 28, an outlet, that is, the isolation output terminal 15 is provided in an exposed condition. Since the isolation output terminal 15 is exposed on the slope 28 downward, it is structurally unlikely that dust or drops of water adhere to the isolation output terminal 15. A plug 29 to be connected to an electric load is inserted upward into the isolation output terminal 15.

The isolation output terminal 15 may have a drip-proof cover in consideration of an outdoor usage, and the front of the casing 100A does not necessarily have to be provided with a stepped face as in FIG. 4 and may be formed in a plane form.

FIG. 1 is an enlarged view of the operation panel 25 provided on the casing 100A. A selection switch for selecting operation modes (operation mode selection switch) 24 is provided on the operation panel 25. The selection switch 24 is a switch used for selecting an interconnected operation mode (interconnection) and an isolated operation mode (isolation), and is composed of a dual-contact switch such as a rotary switch, a toggle switch (can be either a lever type or a seesaw type), and the like. In the interconnected operation mode, not only is a power output from the cogeneration unit interconnected with the system 9, but also an isolated operation is simultaneously prohibited during a power failure of the system. Namely, the interconnected operation mode is a mode where an isolated operation is unavailable during a power failure. The isolated operation mode is an isolated operation-available mode where an isolated operation is enabled during a power failure of the system.

In the operation panel 25, a display screen 30, a gas series setting switch 31, an LED display lamp 32, and a failure reset switch 33 as well as a set switch 34 and a reset switch 35 used when setting operating conditions and a USB terminal 36, and the like are provided in addition to the selection switch 24, however, detailed description of functions and the like will be omitted since this is not a main part of the present invention.

Operations in the case of a system power failure in an interconnected operation mode and an isolated operation mode will now be described. FIG. 6 is a chart showing operation timing in the isolated operation mode. In FIG. 6, when the system has been initialized at a timing t10 not in a system power failure, an operation mode is defined according to a selected position of the selection switch 24 at that time. Here, the isolated operation mode has been selected, and from then onward, an isolated operation is available in this mode. When a power failure has occurred at a timing t11, if it is not an instantaneous power failure, the power failure is detected at a timing t12. Even when the power failure has been detected and the system has been powered off, the cogeneration unit continues output. That is, an isolated operation is automatically started. In a case such that an electric power demand and a heat demand are lost during this power failure, the selection switch 24 is switched to the interconnected operation mode. For example, if the selection switch 24 has been switched to the interconnected operation mode at a timing t13, the isolated operation of the cogeneration unit is forcedly shut down. Here, this is referred to as “forced shutdown” because of the implications that, while an isolated operation of the cogeneration unit has been maintained in the power failure, the isolated operation is forcedly disabled by switching of the selection switch 24.

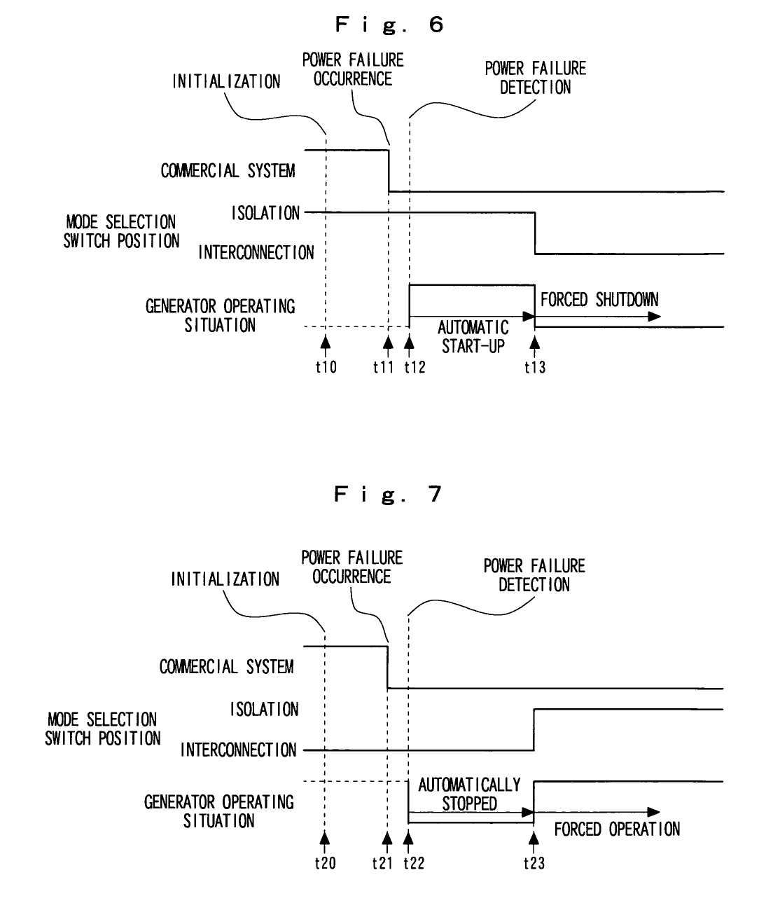

FIG. 7 is a chart showing operation timing in an interconnected operation mode. In FIG. 7, when the system has been initialized at a timing t20 not in a system power failure, an operation mode is defined according to a selected position of the selection switch 24 at that time. Here, the interconnected operation mode has been selected, and no isolated operation is carried out in this mode. When a power failure has occurred at a timing t21, if it is not an instantaneous power failure, the power failure is detected at a timing t22. When the power failure has been detected, the cogeneration unit is prohibited from an isolated operation. Output is automatically stopped if the generator is generating electric power. In a case where an electric power demand and a heat demand arise during this power failure, the selection switch 24 can be switched to the isolated operation mode to carry out an isolated operation. For example, if the selection switch 24 has been switched to the isolated operation mode at a timing t23, the cogeneration unit starts an isolated operation by a forced operation. Here, this is referred to as “forced operation” because of the implications that, while an isolated operation of the cogeneration unit has been automatically prohibited owing to the power failure, the isolated operation is forcedly started by switching of the selection switch 24.

In this connection, the result of power failure detection may be stored in a storage means such as a nonvolatile memory so as to access this storage means to recognize a power failure condition every time the selector switch 24 is switched, or when there is a change in the condition of the selection switch 24, a power failure detecting function may be activated so as to carry out a predetermined processing during a power failure based on that result.

As in the foregoing, according to the present embodiment, since an isolated operation and a shutdown of the isolated operation can be easily selected by the switch that can select at least two conditions during a power failure of the system, an electric power demand and a heat demand during a power failure can be easily satisfied.

While the present invention has been described according to the best mode for carrying out the invention, the present invention can be modified in various modes. For example, the generator 1 can be a fuel cell without limitation to one driven by the engine E. Moreover, without limitation to the cogeneration unit that can satisfy both an electricity demand and a heat demand, the invention can be applied to a power unit that can utilize an electric power generated by an interconnection with a system power supply.

What is claimed is:

1. A power unit having a system interconnection control section that carries out control to interconnect an output of a generator with a system and control to parallel off the output of the generator from the system, capable of connecting the output of the generator to a load in interconnection with the system, comprising:
a power failure detector that detects a power failure of the system; and
a mode selection switch that selects an interconnected operation mode to shut down operation of the generator when a power failure of the system has been detected by the power failure detector and an isolated operation mode to operate the generator after disconnecting the output of the generator from the system when a power failure of the system has been detected by the power failure detector.

2. The power unit according to claim 1 that forms a cogeneration unit along with an exhaust heat recovery section that recovers exhaust heat generated as a result of a power generating operation of the generator.
